(19) United States
(12) Patent Application Publication
(10) Pub. No.: US 2023/0237506 A1
(43) Pub. Date: Jul. 27, 2023

(54) ANTI-FRAUD TECHNIQUES FOR WIRELESS POWER TRANSFER

(71) Applicant: Wireless Advanced Vehicle Electrification, LLC, Salt Lake City, UT (US)

(72) Inventor: Steven Ball, Sandy, UT (US)

(21) Appl. No.: 17/583,077

(22) Filed: Jan. 24, 2022

(51) Int. Cl. G06Q 30/00; H02J 50/80; B60L 53/65

(52) U.S. Cl. CPC G06Q 30/0185; H02J 50/80; B60L 53/65; H02J 50/10

(57) ABSTRACT

Described herein are techniques for providing authorization of vehicle charging requests in a manner that limits losses to unauthorized parties. Such techniques may comprise receiving, from a charging station, a request to access power resources, the request indicating a vehicle identifier, determining, based on the vehicle identifier, vehicle usage data for a vehicle associated with the vehicle identifier, determining expected usage data relevant to the request to access power resources, comparing the vehicle usage data to the expected usage data to identify a variance, and determining whether to authorize or decline the request to access power resources based on the identified variance.

### BACKGROUND

As the world becomes more aware of the impact that the use of fossil fuels is having on the environment, the demand for environmentally friendly alternatives is increasing. In the realm of transportation, vehicles that are powered by fossil fuels are being replaced by electric vehicles. In some cases, entire fleets of transit vehicles, such as busses, are being replaced by electric vehicles. However, despite this increase in popularity, electric vehicles are subject to their own unique set of problems. For example, in many cases, fleets of electric vehicles that are used in public transportation may require frequent and/or extended recharging. This may be facilitated via the placement of charging plates throughout transit routes of those electric vehicles. Such charging plates may be embedded within public roads, such that they may be accessible to vehicles that are not authorized to access power resources. In some cases, drivers of such vehicles may use sophisticated techniques to try to trick such charging plates into providing power.

### SUMMARY

Techniques are provided herein for providing authorization of electric vehicle charging. Such techniques comprise determining usage data for an electric vehicle that is associated with a received request for charging. Additionally, expected usage data may be determined that pertains to usage data that is expected for that vehicle (e.g., from the same vehicle historically, from similar/similarly situated vehicles, etc.). The usage data for the electric vehicle may then be compared to the expected usage data to identify a variance. Such techniques may then comprise granting or restricting access to power resources based on the identified variance. For example, if the identified variance is less than a threshold value, then access to the power resource may be granted whereas if the identified variance is greater than the threshold value, access to the power resource may be restricted. In this example, restricting access may mean preventing access entirely or reducing the amount of power that can be accessed.

In one embodiment, a method is disclosed as being performed by a computing device that manages charging of vehicles via the use of charging plates, such as a charge management platform, the method comprising receiving, from a charging station, a request to access power resources, the request indicating a vehicle identifier, determining, based on the vehicle identifier, vehicle usage data for a vehicle associated with the vehicle identifier, determining expected usage data relevant to the request to access power resources, comparing the vehicle usage data to the expected usage data to identify a variance, and determining whether to authorize or decline the request to access power resources based on the identified variance.

An embodiment is directed to a computing system comprising a processor; and a memory including instructions that, when executed with the processor, cause the computing device to, at least receive, from a charging station, a request to access power resources, the request indicating a vehicle identifier, determine, based on the vehicle identifier, vehicle usage data for a vehicle associated with the vehicle identifier, determine expected usage data relevant to the request to access power resources, compare the vehicle usage data to the expected usage data to identify a variance, and determine whether to authorize or decline the request to access power resources based on the identified variance.

An embodiment is directed to a non-transitory computer-readable media collectively storing computer-executable instructions that upon execution cause one or more computing devices to collectively perform acts comprising receiving, from a charging station, a request to access power resources, the request indicating a vehicle identifier, determining, based on the vehicle identifier, vehicle usage data for a vehicle associated with the vehicle identifier, determining expected usage data relevant to the request to access power resources, comparing the vehicle usage data to the expected usage data to identify a variance, and determining whether to authorize or decline the request to access power resources based on the identified variance.

Embodiments of the disclosure provide numerous advantages over conventional systems. For example, the system disclosed herein enables restriction of access to power resources to unauthorized parties. In some environments, such as those that support electric vehicle public transportation, charging plates are embedded within the road to provide inductive charging of the vehicles as they stop over those charging plates. For example, charging plates may be embedded at bus stops or other charging stations. Because these areas are accessible to the public, other electric vehicle owners may attempt to charge their own vehicles using the charging plates.

An unauthorized vehicle may include any electric vehicle that is not authorized to use charging plates available to the system. In some embodiments, some vehicles may be authorized to use only a subset of the charging plates available and may be considered unauthorized vehicles with respect to the remainder of charging plates. In some systems, vehicle identifiers might be used to determine which vehicles are or are not authorized to access power from a charging plate. However, these vehicle identifiers can be “cloned” in order to disguise an unauthorized vehicle as an authorized vehicle. For example, an unauthorized vehicle may be programmed to provide a vehicle identifier for a bus operating on public transit instead of its own vehicle identifier when requesting access to power. Embodiments of the disclosure herein enable restriction of power to unauthorized vehicles even when rather sophisticated attacks are used by the unauthorized vehicles.

Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example computing environment in which anti-fraud techniques may be implemented to limit unauthorized use of power resources in accordance with at least some embodiments;

FIG. 2 illustrates a block diagram showing various components of an example system architecture that supports restriction of power to unauthorized parties in accordance with some embodiments;

FIG. 3 illustrates a flow chart of an example process by which access to a power source may be granted or restricted in accordance with at least some embodiments;

FIG. 4 depicts an example vehicle charging environment that may be implemented to manage authorization of electric vehicle charging in accordance with at least some embodiments;

FIG. 5 depicts an example environment 500 in which a vehicle fingerprint may be generated as usage data to be used in authorization of a charging request in accordance with at least some embodiments; and

FIG. 6 depicts a flow diagram showing an example process for determining whether to authorize or limit access to power resources in accordance with at least some embodiments.

### DETAILED DESCRIPTION

This disclosure is directed towards a system that prevents or limits power resources from being consumed by unauthorized parties. When an electric vehicle is positioned proximate to a wireless charging plate (e.g., over the charging plate), a request may be submitted to a charge management platform to authorize charging of the vehicle. The charge management platform may then identify usage data associated with the vehicle of the request. Such usage data may include any indication of current usage and/or charging patterns identified with respect to the vehicle. For example, such usage data may comprise charging patterns identified in the recent past.

Additionally, the charge management platform may be configured to identify expected usage data that indicates a baseline or “normal” usage data. The expected usage data may be derived from historical data related to the vehicle to be charged, from data associated with vehicles that are similar, or similarly situated, to the vehicle to be charged, schedule data maintained in relation to the vehicle to be charged, or any other suitable data source. In some cases, the expected data may be generated by aggregating a number of data values from appropriate data sources and identifying a mean or median for those data values.

In embodiments, the usage data for the vehicle is compared to the expected usage data to determine a variance or difference between the two sets of data. If the determined difference is greater than a threshold data value, then the charge management platform may restrict access to the power source. In some cases, this may comprise preventing access to the power resource. In some cases, this may comprise reducing or limiting access to the power resource.

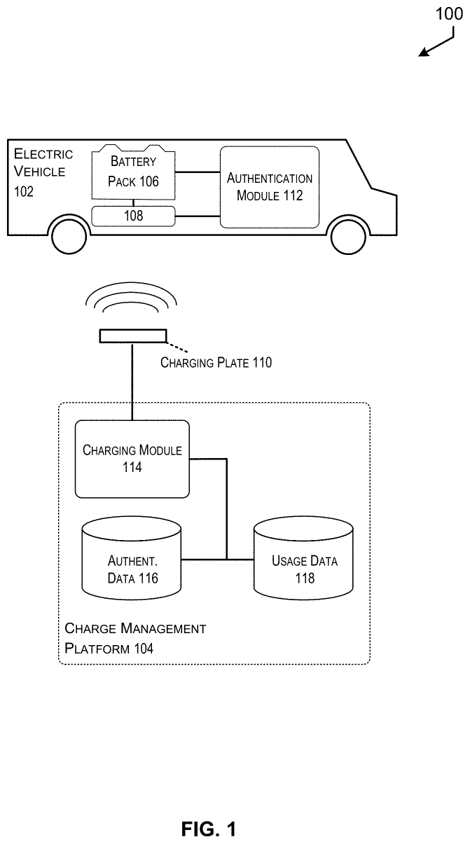

FIG. 1 illustrates a computing environment in which anti-fraud techniques may be implemented to limit unauthorized use of power resources. In some embodiments, the computing environment 100 includes one or more electric vehicles 102 in communication with a charge management platform 104. In at least a portion of these embodiments, the electric vehicle is in continuous or semi-continuous communication with the charge management platform via a wireless communication channel. In at least a portion of these embodiments, the electric vehicle may establish communication with the charge management platform upon arriving at particular access points (e.g., recharging stations and/or bus stops).

An electric vehicle 102 may include any suitable mode of transportation that operates primarily using electric current, e.g., using one or more electric motors to cause the electric vehicle to move. In some embodiments, electric current available to a particular electric vehicle may be limited based on a capacity of a battery or other electric storage medium. In some embodiments, the charge on a battery pack of the electric vehicle may be restored at least partially throughout a vehicle's operation. For example, in the case that the electric vehicle is a bus that makes stops along a route, the battery of the electric vehicle may be recharged at least partially each time that the bus positions itself over a charging pad located at one of the bus stops.

Additionally, the electric vehicle may include a battery pack 106 that is configured to power the electric vehicle. The battery pack may be communicatively coupled to a charge interface 108 that is configured to receive power from a charging plate 110 and direct that power to the battery pack. In some embodiments, the electric vehicle may include an authentication module 112 that is configured to provide authentication data to the charging plate in order to obtain access to the power provided by that charging plate. In some cases, the authentication data provided by the authentication module may include a vehicle identifier (e.g., digital data uniquely associated with the vehicle such as a bit pattern and/or sequence of alphanumeric characters).

The charge management platform 104 may include any computing device or combination of computing devices configured to perform at least a portion of the functionality described herein. Charge management platform may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. Charge management platform can include one or more virtual machines running virtual operating systems, or other computing architectures involving virtualization such as one or more flexible pools of logical storage devices that can be virtualized to maintain virtual storage devices for the computer.

The charge management platform 104 may include one or more software modules configured to limit or otherwise restrict access to power resources, such as charging module 114. In some cases, the charge management platform may maintain data that may be used by the charging module to determine whether to restrict access of one or more vehicles to power to be provided via one or more charging plates. For example, the charge management platform may maintain authentication data 116 that includes information on vehicles that are, or are not, authorized to access power resources managed by the charge management platform. In another example, the charge management platform may maintain usage data 118 that indicates usage behavior patterns associated with one or more drivers and/or vehicles. Usage data 118 may include any suitable data characterizing vehicle usage, for example, vehicle operation, vehicle component operation, vehicle route, vehicle speed, vehicle acceleration, vehicle steering, vehicle breaking, change in battery charge and/or suitable combinations, comparisons and/or statistical characterizations thereof. In some cases, the usage data may include data that has been aggregated across multiple drivers and/or vehicles.

Within a charge management platform, access to charging may be managed by a charging module 114. In some embodiments, the charging module may be configured to receive information about a vehicle from a charging plate, determine whether the information is valid, and either authorize or decline the charging of the vehicle based on that determination. In some embodiments, such a determination is made based upon determining whether usage data particular to the vehicle is within a threshold of variance from an average or typical charging behavior of that vehicle or similar vehicles.

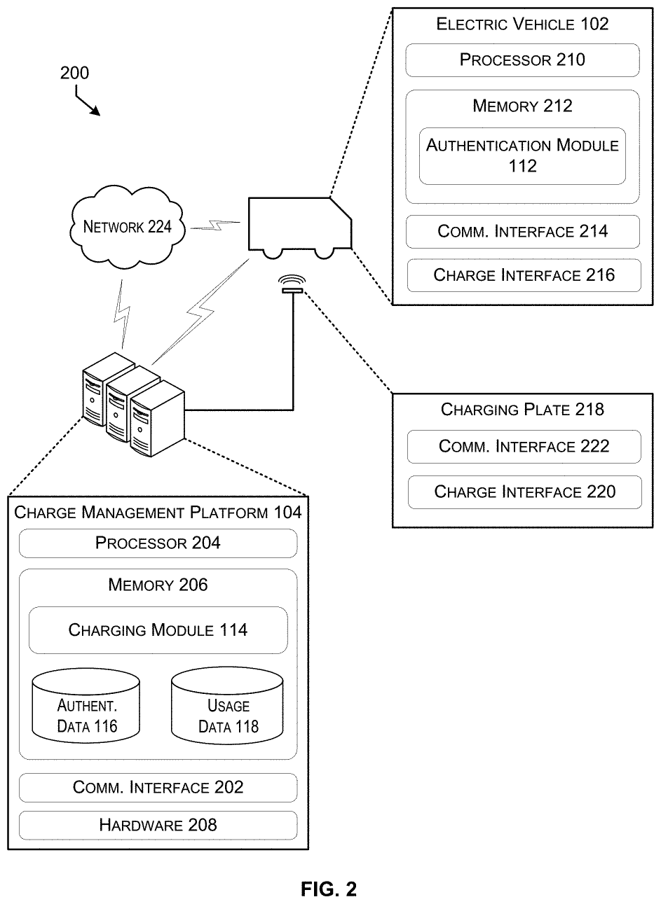

FIG. 2 illustrates a block diagram showing various components of a system architecture that supports restriction of power to unauthorized parties in accordance with some embodiments. The system architecture 200 may include a charge management platform 104 in communication with one or more charging plates 110. In some embodiments, the charge management platform may be in communication with one or more electric vehicles 102.

As noted above, a charge management platform 104 can include any computing device configured to perform at least a portion of the operations described herein. The charge management platform 104 may be composed of one or more general purpose computers, specialized server computers (including, by way of example, PC (personal computer) servers, UNIX® servers, mid-range servers, mainframe computers, rack-mounted servers, etc.), server farms, server clusters, or any other appropriate arrangement and/or combination. The charge management platform 104 can include one or more virtual machines running virtual operating systems, or other computing architectures involving virtualization such as one or more flexible pools of logical storage devices that can be virtualized to maintain virtual storage devices for the computer. For example, the charge management platform 104 may include virtual computing devices in the form of virtual machines or software containers that are hosted in a cloud.

The charge management platform 104 may include a communication interface 202, one or more processors 204, memory 206, and hardware 208. The communication interface 202 may include wireless and/or wired communication components that enable the charge management platform 104 to transmit data to, and receive data from, other networked devices. The hardware 208 may include additional user interface, data communication, or data storage hardware. For example, the user interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

The memory 206 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, DRAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanisms.

The one or more processors 204 and the memory 206 of the charge management platform 104 may implement functionality that includes one or more software modules and data stores. Such software modules may include routines, program instructions, objects, and/or data structures that are executed by the processors 204 to perform particular tasks or implement particular data types. More particularly, the memory 206 may include at least a module that is configured to manage access to power resources as provided via one or more charging plates (e.g., charging module 114). Additionally, the charge management platform may maintain one or more data stores having data to be used by the charging module to make a determination as to whether or not to grant access. For example, the charge management platform may include authentication data 116, that includes an indication of what vehicles/drivers are authorized to access power resources, and/or usage data 118, that includes information on charging patterns/usage.

A charging module 114 may be configured to, in conjunction with the processor 204, manage access to power resources that are distributed to electric vehicles via charging plates. In some embodiments, the charging module is configured to determine whether or not to authorize a charging plate to distribute power to a vehicle that is requesting charging. Such a determination may be made by comparing charging activity for the requesting vehicle to expected charging activity. For example, upon receiving a request for charging from a vehicle, a set of expected charging activity data may be generated from usage data. Once expected charging activity data has been generated, a determination may be made as to whether or not to allow access to power based on a comparison between the charging activity for the requesting vehicle and the expected charging activity. In some embodiments, such a determination may be made based on a variance between the two data or a determination that the charging activity represents a statistical outlier in relation to the expected charging activity.

In some cases, the set of expected charging activity data is generated based on historic charging data for the vehicle that is requesting charging. In these cases, the expected charging activity data may include an indication of typical charging times/amounts for that vehicle. A determination may then be made as to whether the current charging activity is typical of the vehicle based on the expected charging activity data.

In some cases, the set of expected charging activity data is generated based on average charging data for vehicles that are similar to, or similarly situated to, the requesting vehicle. For example, if the requesting vehicle is an electric bus that is assigned to a particular transit route, then the set of expected charging activity data is generated based on charging patterns for other electric busses that have been assigned to that same transit route. A determination may then be made as to whether the current request for charging is typical of the vehicles assigned to that transit route based on the expected charging activity data.

The charging module may be configured to restrict access to power in a number of different ways. In some embodiments, the charging module may outright deny the request for access to power. In some embodiments, the charging module may restrict or limit the amount of power that is provided to the requesting vehicle. For example, upon determining that current charging activity is not typical, (e.g., based on the comparison to expected charging activity data) the charging module may make a determination to allow the vehicle to charge, but at a reduced rate or to a reduced maximum amount.

A noted elsewhere, an electric vehicle 102 may comprise any suitable vehicle that is primarily powered using electrical current. In addition to including various components required to enable transit, the electric vehicle may include one or more processors 210, a memory 212, a communication interface 214, and charge interface 108.

The one or more processors 210 and the memory 212 of the charge management platform 104 may implement functionality that includes one or more software modules and data stores. Such software modules may include routines, program instructions, objects, and/or data structures that are executed by the processors 210 to execute one or more functions of the electric vehicle. More particularly, the memory 212 may include at least a module that is configured to facilitate authentication of the vehicle to a charging plate (e.g., authentication module 112).

An authentication module 112 may be configured to, in conjunction with the processor 210, provide access credentials to a charging plate in order to initiate a charging session. In some embodiments, the authentication module is configured to provide an identifier (e.g., a vehicle identifier) to the charging plate. In some embodiments, the authentication module is configured to provide payment data to the charging plate that can be used to pay for a charging session.

In some embodiments, the charge management platform may be in communication with at least one charging plate 218. A charging plate may be any device or mechanism capable of providing wireless transmission of power (e.g., inductive charging) to an electrical vehicle located in proximity of the charging plate via a charge interface 220. In some embodiments, the charging plate may be configured to communicate with an electric vehicle in its proximity (e.g., to receive a vehicle identifier, etc.) via a communication interface 222.

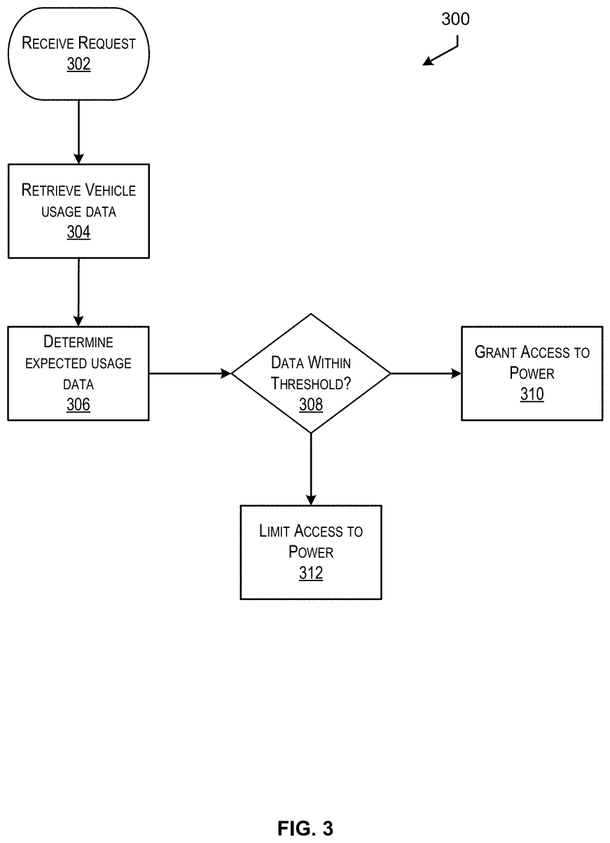

FIG. 3 illustrates a flow chart process by which access to a power source may be granted or restricted in accordance with at least some embodiments. The process 300 involves a number of interactions between various components of the computing environment described with respect to FIG. 1.

At 302, the process 300 comprises receiving a request for access to a power supply. The request may be received from a charging plate and may indicate a vehicle to be charged. In some embodiments, the indication of the vehicle to be charged may comprise a vehicle identifier that is unique to that vehicle. In some embodiments, the charge management platform may establish a communication session between itself and an electric vehicle in proximity of a charging plate. In these embodiments, the electric vehicle may provide its vehicle identifier to the charge management platform via that communication session. In some embodiments, a current geographic location is associated with the charging request. In some embodiments, such a geographic location may be determined based on a known location of the charging plate involved in the request.

In some embodiments, an initial check may be performed to ensure that the received vehicle identifier is authorized to receive power. In some embodiments, the vehicle identifier is checked against a whitelist of vehicle identifiers that are authorized to receive power from the charging plate. In some embodiments, the vehicle identifier is checked against a blacklist to ensure that the vehicle identifier is not one that is restricted from receiving power from the charging plate. Such a whitelist or blacklist may be stored locally on a memory communicatively coupled to the charging plate.

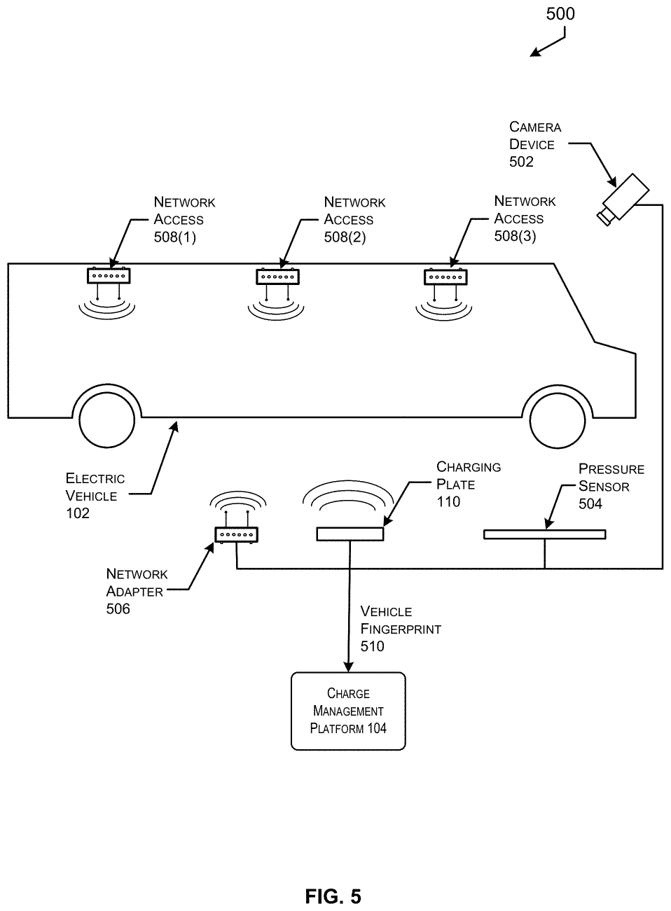

At 304, the process 300 comprises identifying the vehicle to which the request relates and retrieving charge/usage data for that vehicle. In some embodiments, such data comprises information about locations visited by, or to be visited by, the electric vehicle. For example, the data may indicate geographic locations recently visited (e.g., within the last month, etc.) by the electric vehicle. In another example, the electric vehicle's scheduled future stops may be determined from transit route schedule data. In some embodiments, the data may include an indication of timing and/or amounts of charging by the electric vehicle. In some cases, the usage data may comprise information about physical aspects of the vehicle to be charged. For example, the usage data may indicate a current weight of the vehicle as obtained from a nearby pressure sensor. In another example, the usage data may indicate a color of the vehicle as obtained from a nearby camera device. In some embodiments, the usage data may indicate a network identifier (or combination of network identifiers) that are detected via a local wireless network connection. This is described in greater detail with respect to FIG. 5 below.

At 306, the process 300 comprises identifying expected charge/usage data in relation to the received request. In some embodiments, expected charge/usage data is generated based on past charge/usage information stored in relation to the electric vehicle to be charged. For example, data about past charging activities may be aggregated to determine a normal or expected level of activity (e.g., an average). Such expected data may indicate an amount of charge that is typically requested, a frequency (e.g., a number of times per period of time) that the electric vehicle requests charging, a location or general area in which the electric vehicle is expected to be, or any other suitable information that may be determined based on historic data. In some cases, the expected charge/usage data is generated based on schedule information stored about the electric vehicle. For example, in the case that

In some embodiments, the expected charge/usage data is generated based on information about other electric vehicles that are similar to, or at least similarly situated to, the electric vehicle associated with the request. For example, if the electric vehicle is a public transit bus that is assigned to a particular transit route, then the expected charge/usage data may indicate an average frequency or amount of charge that is requested by other busses assigned to the particular transit route at the respective charging plate. In another example, the expected charge/usage data may comprise information about a rate of discharge for vehicles of the same make/model as the vehicle associated with the request. In this example, a rate of discharge may be calculated for the vehicle associated with the request based on information about amounts and frequencies of charging requested/performed with respect to that vehicle.

At 308, the process 300 comprises comparing the charge/usage data for the vehicle to the expected charge/usage data. Such a comparison may result in an identification of a variance or degree of difference between the two data. A determination may then be made as to whether that variance is within, or less than, a threshold variance value. In some embodiments, the threshold value may be a static value that is predetermined based on the type of data being compared. In some embodiments, the threshold value may be dynamically determined based on the data being compared. For example, the threshold value may be a percentage or fraction of one or more data values. In another example, the threshold value may be determined based on a related probability. For example, a determination may be made as to a range of values that, outside of which a data value would be considered a statistical outlier.

It should be noted that any number of different types of charge/usage data may be compared at 308. In some cases, a frequency of charges or an amount of power usage for a vehicle may be compared to that of other vehicles that are of a similar type and/or travel a similar amount. In some cases, the location of a request for charge by a vehicle may be compared to an expected location or area for that vehicle. In some embodiments, such an expected location or area may be determined based on historic patterns for that vehicle. In some embodiments, such an expected location or area may be determined based on a possible reach or range of the vehicle from its latest charge location given an elapsed time, traffic conditions, etc.

At 310, upon determining that the determined variance is within a threshold (e.g., “Yes” from block 308) the process 300 comprises responding to the request by granting access to the power resource. In this case, power may be directed to the charging plate in an amount that is sufficient to complete the request. In some cases, the amount of power directed to the charging plate may be limited to a predetermined amount.

At 312, upon determining that the determined variance is not within a threshold (e.g., “No” from block 308) the process 300 comprises limiting access to the power resource. In some embodiments, the charge management platform may deny the request outright. In such a case, no power is provided to the charging plate to be used to charge the electric vehicle. In some embodiments, power may be provided to the charging plate at a reduced rate or in a reduced amount. In some embodiments, additional actions may be taken at 312. For example, in some cases a picture may be captured of the vehicle for which charging is requested. That picture may then be provided to law enforcement or another entity.

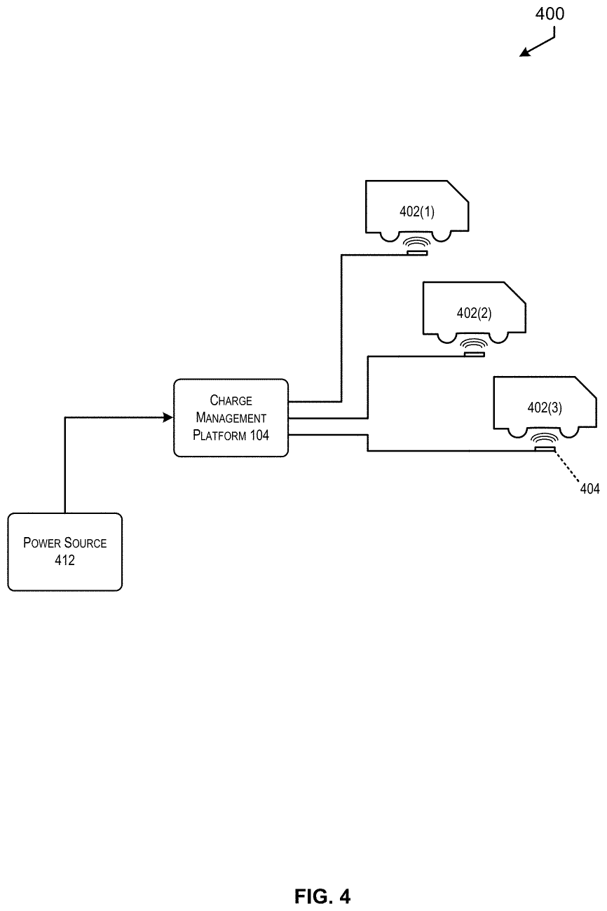

FIG. 4 depicts a vehicle charging environment that may be implemented to manage authorization of electric vehicle charging in accordance with at least some embodiments. In some embodiments, the environment 400 depicted in FIG. 4 may be implemented to service a number of electric vehicles 402 within region or area. In such embodiments, a charge management platform 104 may be in communication with a number of charging plates 404, each of which may be embedded in roadways or other accessible areas throughout the region.

Each of a number of electric vehicles 402 (e.g., electric vehicles 402 (1-3)) may be configured to interact with the charging plates 404 in order to receive a power transfer (e.g., via inductive charging). An electric vehicle may be positioned over a respective charging plate 404, and each charging plate may be configured to provide power to the electric vehicle positioned above it. Such power may be provided by the charging plate to the electric vehicle via either wired or wireless means. In some embodiments, the charging plate may receive information from the electric vehicle (and/or a battery pack installed within the vehicle), such as an identifier and/or status information, which may be relayed to another computing device (e.g., the charge management platform).

Power may be distributed to each of a number of charging plates by the charge management platform 104. In some embodiments, the charge management platform may receive (either from a charging plate or from an electric vehicle) an indication of which electric vehicle is positioned at which charging plate. The charge management platform may receive charge requests from one or more of the charge plates distributed throughout the environment and may subsequently determine whether or not to authorize each of those received requests based on a comparison between vehicle usage/charging data and expected usage/charging data. Based on such an authorization, the charge management platform may further determine whether to grant access to, or to limit access to, power that is to be distributed to one or more of the charging plates to be used in charging a respective electric vehicle.

In some embodiments, the charge management platform may make an authorization determination based on a likelihood that a vehicle requesting charging is actually the vehicle in question. It should be noted that, with the use of “cloned” vehicle identifiers, a vehicle may not actually be the vehicle that it represents itself as. In some systems, a dynamic approach may be used to verify the authenticity of the vehicle's identification. However, components of a legacy system may not be capable of performing such dynamic verification. Hence, embodiments of the charge management platform as described herein enable verification of vehicles without the use of dynamic verification techniques by detecting variances between detected usage and expected usage.

To make an authorization determination, the charge management platform may make determine whether a variance between the vehicle usage/charging data and the expected usage/charging data is greater than some predetermined threshold value. For example, in some cases, the charge management platform may determine a likely geographic position of a vehicle based on either historic data (e.g., recent charging data) or charging patterns (e.g., frequently used charging locations). In this example, the charge management platform may compare an actual geographic location associated with the received charge request to the likely geographic location and may determine whether the vehicle is likely the vehicle associated with the received vehicle identifier based on a variance (e.g., a distance) between the two geographic locations.

In another example, in some cases, the charge management platform may determine an expected charging frequency associated with the electric vehicle to be charged based on historic charging data for that vehicle. In this example, the charge management platform may determine a number of times that the vehicle tends to be charged over a predetermined period of time. Additionally, the charge management platform may determine a current charging frequency for the vehicle based on a number of times that the vehicle has been charged over a shorter, and more recent, period of time. In this example, if the current charging frequency is significantly greater than the expected charging frequency (e.g., a variance between the two is greater than a threshold value), then a determination may be made that an unauthorized vehicle may be using a vehicle identifier for that vehicle. In this scenario, rather than restrict access entirely (which would impact the actual vehicle negatively), the charging management platform may limit the amount of power distributed to the vehicle during charging sessions or mate restrict the rate at which power is transferred to that vehicle via the charging plates.

In the depicted vehicle charging environment, the charging module may be in communication with an energy grid that supplies power to one or more charging plates. Such an energy grid may draw power from at least one power source 412. In some embodiments, the power source may include at least one external source of power and/or at least one energy storage device, such as a battery. Grid-level energy storage can reduce supply and demand mismatch by shifting energy from times of low demand to high demand, or from times when external power is cheap to when it is expensive. Additionally, energy storage can be charged or discharged rapidly, which can reduce the dependency on fast (e.g., high current) external power sources. In some embodiments, such an energy storage device can provide power quality, load shifting, load leveling, energy management, frequency regulation, backup power, voltage support, and/or grid stabilization.

FIG. 5 depicts an example environment 500 in which a vehicle fingerprint may be generated as usage data to be used in authorization of a charging request. In embodiments, an electric vehicle 102 to be charged may position itself in proximity to (e.g., above) a charging plate 110. In some embodiments, as depicted in FIG. 5, various external sensors may be used to collect information about the electric vehicle that may be used to authorize a charging request.

In some embodiments, various physical attributes of the electric vehicle may be ascertained by one or more sensors in the vicinity of the electric vehicle. For example, a color and/or size of the electric vehicle may be ascertained using one or more machine vision techniques as implemented on images captured via a camera device 502. In another example, an approximate weight may be obtained for the electric vehicle using one or more pressure sensors embedded within a driving surface (e.g., a road). It should be noted that while weight, color, and size are presented in the examples here, these are merely some non-limiting examples of physical attributes that may be identified with respect to a vehicle. Any suitable physical attributes may be obtained. In some embodiments, the camera device may be used, along with optical character recognition techniques, to read a license plate on the electric vehicle.

In some embodiments, network identifiers may be identified with respect to the electric vehicle. In many public transportation systems, transport vehicles are often equipped with public access points that may be used to connect to a network (e.g., network adapters) via short-range wireless communication. In some cases, each public transit vehicle may include multiple such access points spread throughout the vehicle. Note that each such access point may have a different network identifier. In some embodiments, a network adapter 506 may be positioned proximate to the charging plate in a manner that it is able to perform a discovery process in order to obtain network identifiers from proximate network access points. In such embodiments, upon detecting that a vehicle is requesting charging, the network adapter may be configured to identify local network access points 508 (1-3) that are active on the vehicle.

In the example environment 500, a vehicle fingerprint 510 may be generated from information collected about the electric vehicle 102. Such a vehicle fingerprint may include an indication of one or more physical attributes of the vehicle (as detected via one or more sensors located proximate to the vehicle) as well as an indication of a combination of network identifiers that have been detected as being active within the vehicle. In some cases, each of the data included in the vehicle fingerprint may be assigned a weight that indicates its importance in identifying a respective vehicle.

In some embodiments, a vehicle fingerprint may be received as usage data for a vehicle along with a request for charging. In these embodiments, the received vehicle fingerprint may be compared to a vehicle fingerprint stored in relation to the identified vehicle (i.e., expected usage data) in order to determine a likelihood that the vehicle is authentic. In these embodiments, a determination may be made as to a degree to which the two fingerprints match. It should be noted that matches may not be exact. For example, one or more of the network access points 508 may be offline when the vehicle requests charging. In another example, the vehicle may have a significant number of passengers onboard, resulting in a much greater weight than is otherwise associated with the vehicle. In these embodiments, the request for charging may be authorized or declined based on the degree to which the vehicle fingerprints match and whether that degree is above or below a threshold value. For example, given that a determination is made that there is a 76% likelihood of a match between the received vehicle fingerprint and the vehicle fingerprint stored in relation to a vehicle, the request may be authorized if the threshold value is 75% whereas the request may be declined it the threshold value is 80%.

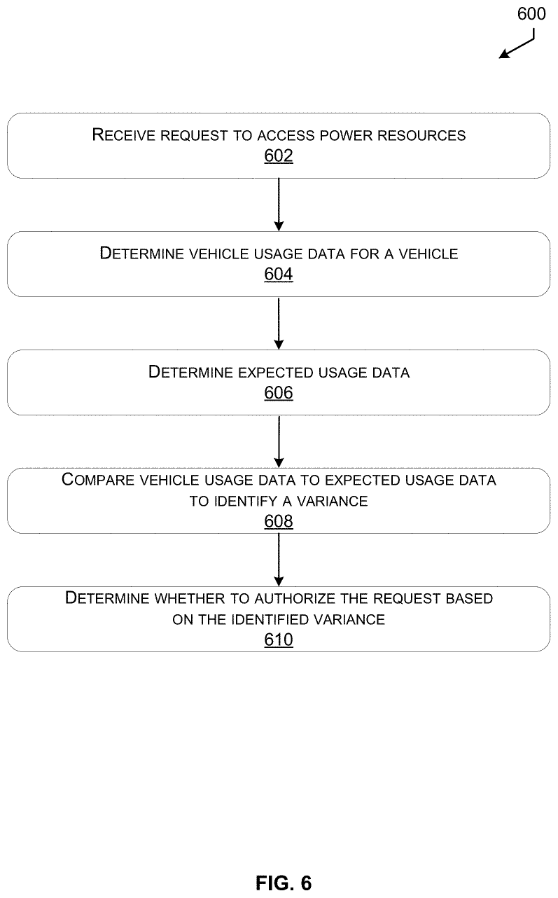

FIG. 6 depicts a flow diagram showing an example process flow 600 for determining whether to authorize or limit access to power resources in accordance with embodiments. The process 600 may be performed by a computing device that is configured to generate and provide a product strategy for a product. For example, the process 600 may be performed by a computing device configured to manage at least a portion of fleet operations, such as the charge management platform 104 described with respect to FIG. 1 above.

At 602, the process 600 comprises receiving a request to access power resources managed by a charging plate. The request may comprise at least a vehicle identifier to be used in identifying the vehicle that is requesting to be charged. In some embodiments, the vehicle identifier is received by the charging station from the vehicle via a short-range wireless communication session and is subsequently relayed to the charge management platform.

At 604, the process 600 comprises determining vehicle usage data for the vehicle. The usage data may comprise any suitable information about activities by the vehicle. For example, the usage data may comprise one or more of a current frequency of charging, an amount of charging requested, locations visited by the vehicle, or locations to be visited by the vehicle.

In some embodiments, vehicle usage data comprises a current vehicle fingerprint. A current vehicle fingerprint may include information about a combination of attributes for the vehicle. In some cases, the combination of attributes for the vehicle comprises one or more physical attributes as determined via sensor data collected from one or more sensors in the vicinity of the vehicle. For example, the one or more physical attributes may comprise one or more of a color, weight, or size of the vehicle. In some embodiments, the combination of attributes for the vehicle comprises information about one or more network access points identified with respect to the vehicle. For example, a number of network access points associated with the vehicle may be discovered by a network adapter located in proximity to a charging plate through a discovery process. In this example, the network adapter may relay identifiers for the network access points to the charge management platform.

At 606, the process 600 comprises determining expected usage data for the vehicle. In some embodiments, the expected usage data is generated from historic data for the vehicle. For example, the expected usage data may be generated based on historic charging data stored in relation to the vehicle for which charging is being requested. In some embodiments, the expected usage data is generated from information about other vehicles that are similar to, or similarly situated to, the vehicle. For example, the expected usage data may be generated from information stored in relation to vehicles that are determined to be of the same make, model, or size as the vehicle requesting charging. In another example, the expected usage data may be generated from information stored in relation to vehicles that are assigned the same transit route as the vehicle requesting charging. In some embodiments, the expected usage data comprises a mean or median determined from a set of data sources.

At 608, the process 600 comprises comparing vehicle usage data to expected usage data to identify a variance. Such a variance may be identified as a difference between the vehicle usage data and the expected usage data. In some embodiments, the variance may represent a degree to which the vehicle usage data does or does not match the expected usage data.

In embodiments, in which the usage data comprises a current vehicle fingerprint, the expected usage data may comprise a stored vehicle fingerprint that is maintained in relation to the vehicle and comparing the vehicle usage data to the expected usage data comprises determining a degree to which the current vehicle fingerprint matches the stored vehicle fingerprint. In some cases, this may be represented as a percentage likelihood that there is a match (e.g., that the vehicle requesting charging is the vehicle on record).

At 610, the process 600 comprises determining whether to authorize the request based on the identified variance. In some embodiments, determining whether to authorize or decline the request to access power resources comprises determining whether the identified variance is greater than a threshold value. Such a threshold value may represent a percentage of a data value in the expected usage data.

### CONCLUSION

Although the subject matter has been described in language specific to features and methodological acts, it is to be understood that the subject matter defined in the appended claims is not necessarily limited to the specific features or acts described herein. Rather, the specific features and acts are disclosed as exemplary forms of implementing the claims.

1. A method comprising:
receiving, from a charging station, a request to access power resources, the request indicating a vehicle identifier;
determining, based on the vehicle identifier, vehicle usage data for a vehicle associated with the vehicle identifier;
determining expected usage data relevant to the request to access power resources;
comparing the vehicle usage data to the expected usage data to identify a variance; and
determining whether to authorize or decline the request to access power resources based on the identified variance.

2. The method of claim 1, wherein determining whether to authorize or decline the request to access power resources comprises determining whether the identified variance is greater than a threshold value.

3. The method of claim 2, wherein the threshold value represents a percentage of a data value in the expected usage data.

4. The method of claim 1, wherein the expected usage data is generated from historic data for the vehicle.

5. The method of claim 1, wherein the expected usage data is generated from information about other vehicles that are similar to, or similarly situated to, the vehicle.

6. The method of claim 1, wherein the usage data comprises one or more of a current frequency of charging, an amount of charging requested, locations visited by the vehicle, or locations to be visited by the vehicle.

7. The method of claim 1, wherein the expected usage data comprises a mean or median determined from a set of data sources.

8. The method of claim 1, wherein the vehicle identifier is received by the charging station from the vehicle via a short-range wireless communication session.

9. The method of claim 1, wherein the variance is identified as a difference between the vehicle usage data and the expected usage data.

10. A computing device comprising:
a processor; and
a memory including instructions that, when executed with the processor, cause the computing device to, at least:
receive, from a charging station, a request to access power resources, the request indicating a vehicle identifier;
determine, based on the vehicle identifier, vehicle usage data for a vehicle associated with the vehicle identifier;
determine expected usage data relevant to the request to access power resources;
compare the vehicle usage data to the expected usage data to identify a variance; and
determine whether to authorize or decline the request to access power resources based on the identified variance.

11. The computing device of claim 10, wherein the vehicle usage data comprises a current vehicle fingerprint.

12. The computing device of claim 11, wherein the current vehicle fingerprint comprises information about a combination of attributes for the vehicle.

13. The computing device of claim 12, wherein the combination of attributes for the vehicle comprises one or more physical attributes as determined via sensor data collected from one or more sensors in the vicinity of the vehicle.

14. The computing device of claim 13, wherein the one or more physical attributes comprise one or more of a color, weight, or size of the vehicle.

15. The computing device of claim 12, wherein the combination of attributes for the vehicle comprises information about one or more network access points identified with respect to the vehicle.

16. The computing device of claim 10, wherein the expected usage data comprises a stored vehicle fingerprint that is maintained in relation to the vehicle and comparing the vehicle usage data to the expected usage data comprises determining a degree to which the current vehicle fingerprint matches the stored vehicle fingerprint.

17. The computing device of claim 16, wherein the variance is represented as a percentage likelihood that there is a match.

18. A non-transitory computer-readable media collectively storing computer-executable instructions that upon execution cause one or more computing devices to collectively perform acts comprising:
receiving, from a charging station, a request to access power resources, the request indicating a vehicle identifier;
determining, based on the vehicle identifier, vehicle usage data for a vehicle associated with the vehicle identifier;
determining expected usage data relevant to the request to access power resources;
comparing the vehicle usage data to the expected usage data to identify a variance; and
determining whether to authorize or decline the request to access power resources based on the identified variance.

19. The non-transitory computer-readable media of claim 18, wherein determining whether to authorize or decline the request to access power resources comprises determining whether the identified variance is greater than a threshold value.

20. The non-transitory computer-readable media of claim 18, wherein the vehicle usage data comprises a current vehicle fingerprint and the expected usage data comprises a stored vehicle fingerprint that is maintained in relation to the vehicle.
